(19) United States
(12) Patent Application Publication
(10) Pub. No.: US 2015/0278367 A1
(43) Pub. Date: Oct. 1, 2015

(54) Determination and Presentation of Content from Connections

(71) Applicant: Google Inc., Mountain View, CA (US)

(72) Inventors: Austin Chang, New York, NY (US); Tomasz Charytoniuk, San Francisco, CA (US); Doug Sherrets, Mountain View, CA (US); Ben Tauber, Mountain View, CA (US)

(21) Appl. No.: 13/658,602

(22) Filed: Oct. 23, 2012

Related U.S. Application Data
(60) Provisional application No. 61/671,626, filed on Jul. 13, 2012.

(51) Int. Cl. G06F 17/30

(52) U.S. Cl. CPC G06F 17/30867; G06F 17/3053; G06F 17/30528; G06F 17/30256; G06Q 50/01

(57) ABSTRACT

The disclosure includes a system and method for providing determined content to users. The system includes a social network engine, an affinity module, an optimization module and a content determination module. The social network engine receives registration data from a first user. The affinity module determines one or more affinities between the first user and one or more second users. The optimization module optimizes a content type for the first user. The content determination module determines content of the optimized content type published by the one or more second users and combines the determined content to generate a post based on the one or more affinities. The content determination module provides the post to the first user.

### CROSS REFERENCE TO RELATED APPLICATIONS

This application claims priority under 35 USC §119(e) to U.S. Application No. 61/671,626, entitled “Determination and Presentation of Content from Connections” filed Jul. 13, 2012, the entirety of which is herein incorporated by reference.

### BACKGROUND

The specification relates to optimizing and providing content to users in a social network.

For a new user who recently joined a social network, the experience in the social network may be less interesting if the new user merely connects to a few other users and a limited amount of content from the other connected users can be presented to the new user. Existing systems usually focus on recent content published by the new user's connections and present the recent content to the new user. For example, existing systems focus on providing content posted in the last few days by other users that the new user explicitly chooses to connect to.

### SUMMARY

According to one innovative aspect of the subject matter described in this disclosure may be embodied in methods that include determining one or more affinities between a first user and one or more second users; determining a content type for the first user based on the first user's activities associated with a social network; determining at least two pieces of determined content of the determined content type published by the one or more second users; combining the at least two pieces of determined content to generate a post based on the one or more affinities; and providing the post to the first user.

Other aspects include corresponding methods, systems, apparatus, and computer program products for these and other innovative aspects.

These and other implementations may each optionally include one or more of the following features. For instance, the operations further include: highlighting one of the pieces of content in the post based on the affinity between the first user and the second user; ranking the determined content based on the one or more affinities; generating the post based on one or more top-ranking pieces of content from the one or more pieces of content; determining a user reaction to the post from the first user; updating content presentation based on the user reaction; and ranking the one or more affinities among the one or more second users based on one or more connections between the first user and the one or more second users. For instance, the features include: the determined content including one or more photo albums published by the one or more second users and the post including a combined photo album that includes one or more photos from the one or more photo albums; determining contextual data associated with the first user; determining metadata associated with a set of posts published by the one or more second users; and determining a subset of posts from the set of posts based on the metadata and the contextual data, the determination of the content based on behavior data associated with the first user.

The present disclosure may be particularly advantageous in a number of respects. First, the system does not impose restrictions on the publication time of the content. The system can provide content to a first user without limiting a publication time. For example, the system provides a feed including content published one day ago, one month ago or one year ago, etc. Second, the system can provide content published by other users who may be explicitly connected to the first user as well as some other users who may not be explicitly connected to the first user. Third, the system may optimize the content in a variety of ways and provide the optimized content to the first user. For example, the system may optimize a content type, ranks the content and combines the content to generate a post. Fourth, the system may determine a user reaction with the presented content and update the presentation based on the user reaction.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for providing content to users.

FIG. 2 is a block diagram illustrating an example of a suggestion application.

FIG. 3 is a flowchart of an example method for providing content to users.

FIG. 4 is a flowchart of another example method for providing content to users.

FIG. 5 is a flowchart of an example method for optimizing content types.

FIG. 6 is a graphic representation of an example user interface for providing content to a user in a social network on a single page.

FIG. 7 is a graphic representation of an example user interface for providing content to a user in an electronic message.

FIG. 8 is a graphic representation of an example user interface for providing content to a user that is part of a website.

### DETAILED DESCRIPTION

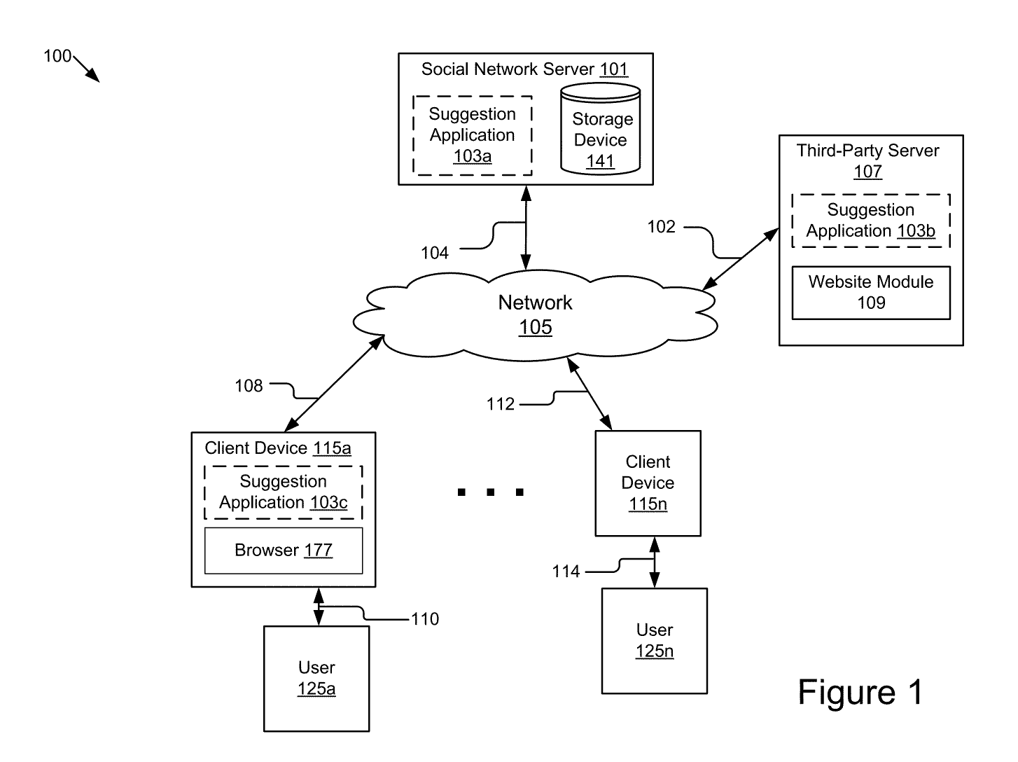

FIG. 1 illustrates a block diagram of some implementations of a system 100 for providing content to a user. The illustrated system 100 includes client devices 115a . . . 115n that can be accessed by users 125a . . . 125n, a social network server 101 and a third-party server 107. In FIG. 1 and the remaining figures, a letter after a reference number, e.g., “115a,” represents a reference to the element having that particular reference number. A reference number in the text without a following letter, e.g., “115,” represents a general reference to instances of the element bearing that reference number. In the illustrated implementation, these entities of the system 100 are communicatively coupled via a network 105.

The client devices 115a, 115n in FIG. 1 are used by way of example. While FIG. 1 illustrates two client devices 115a and 115n, the present disclosure applies to a system architecture having one or more client devices 115. Furthermore, although FIG. 1 illustrates one network 105 coupled to the client devices 115, the social network server 101 and the third-party server 107, in practice one or more networks 105 can be connected to these entities.

In some instances, the suggestion application 103a may be operable on the social network server 101, which is coupled to the network 105 via signal line 104. The social network server 101 can be a hardware server that includes a processor, a memory and network communication capabilities. In some implementations, the social network server 101 sends and receives data to and from one or more of the client devices 115a, 115n and the third-party server 107 via the network 105. The social network server 101 also includes a storage device 141 and a social network application (not shown) that can be part of the suggestion application 103a or a standalone application. The storage device 141 stores a social graph that includes the relationship between people in a social network and an interest graph that includes interests associated with the users. For example, when a first user follows a second user, the relationship is a first-degree relationship. If the second user follows a third user that the first user does not follow, the first user has a second-degree relationship with the third user. This relationship can also be described in terms of social affinity. The first user has a closer social affinity to the second user than the third user.

Furthermore, the social network server 101 may be representative of one social network and there may be multiple social networks coupled to the network 105, each having its own server, application and social graph. For example, a first social network may be more directed to business networking, a second may be more directed to or centered on academics, a third may be more directed to local business, a fourth may be directed to dating and others may be of general interest or a specific focus.

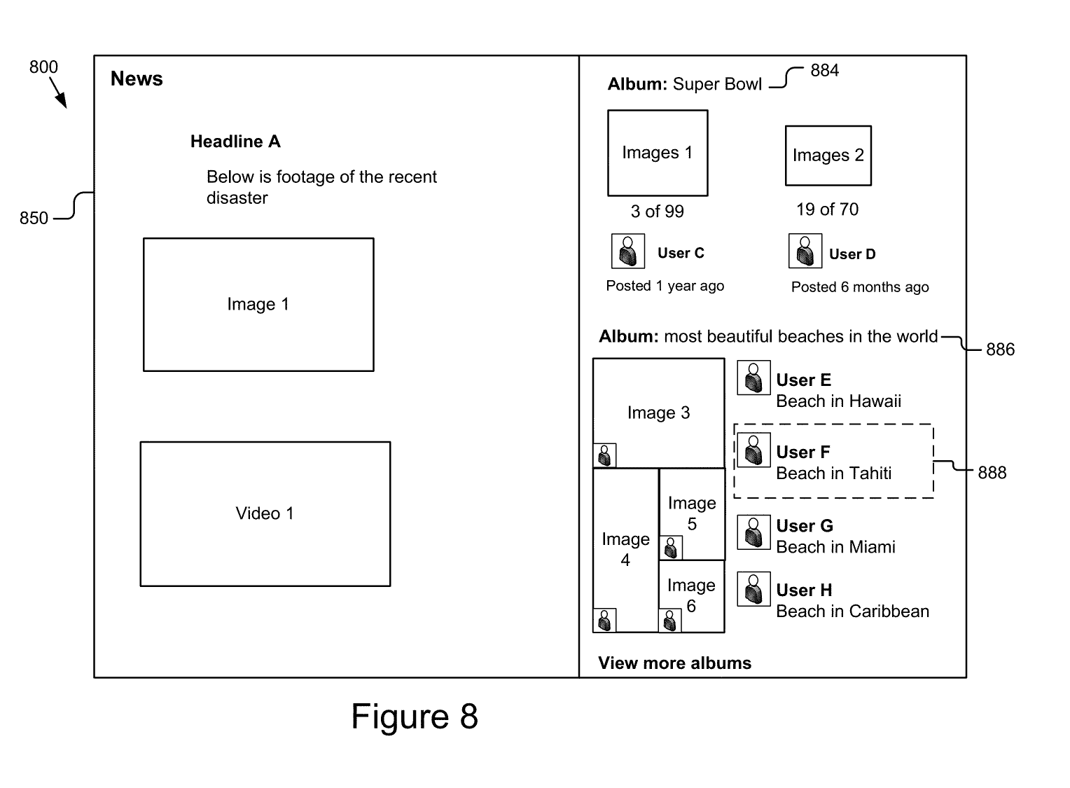

In some instances, the suggestion application 103b may be stored on a third-party server 107, which is connected to the network 105 via signal line 102. In some implementations, the third-party server 107 can be a hardware server that includes a processor, a memory and network communication capabilities. The third-party server 107 sends and receives data to and from other entities of the system 100 via the network 105. In some instances the third-party server 107 includes a website module 109 for generating a website. In this example, the suggestion application 103b could be an application programming interface (API) for requesting information from the social network server 101 about users associated with the social network. The website module 109 incorporates the social information into the website. For example, the suggestion application 103b generates content that the website module 109 incorporates into a website to add a social component to the website. Additional information about this example can be found with reference to FIG. 8. While FIG. 1 includes one third-party server 107, the system 100 may include one or more third-party servers 107.

In some instances, the suggestion application 103c may be stored on a client device 115a, which is connected to the network 105 via signal line 108. In some implementations, the client device 115a, 115n may be a computing device that includes a memory and a processor, for example a laptop computer, a desktop computer, a tablet computer, a mobile telephone, a personal digital assistant (PDA), a mobile email device, a portable game player, a portable music player, a television with one or more processors embedded therein or coupled thereto or other electronic device capable of accessing a network 105. In some instances, the client device 115a includes a browser 177 for accessing online services. In the illustrated implementation, the user 125a interacts with the client device 115a via signal line 110. The client device 115n is communicatively coupled to the network 105 via signal line 112. The user 125n interacts with the client device 115n via signal line 114. In some instances, the suggestion application 103c acts in part as a thin-client application that may be stored on the client device 115a, 115n and in part as components that may be stored on the social network server 101. For example, the social network server 101 stores the user data in the storage device 141 and generates recommendations for the user 125a. The suggestion application 103c sends instructions to the browser 177 to display the content.

The suggestion application 103 can be code and routines for aggregating and presenting content to a user in a social network. In some instances, the suggestion application 103 can be implemented using hardware including a field-programmable gate array (FPGA) or an application-specific integrated circuit (ASIC). In some other instances, the suggestion application 103 can be implemented using a combination of hardware and software. In some instances, the suggestion application 103 may be stored in a combination of the devices and servers, or in one of the devices or servers.

In some instances, the suggestion application 103 receives registration data from a first user and registers the first user with the social network. The suggestion application 103 determines one or more affinities between the first user and one or more other users. An affinity between a first user and a second user may be data describing a degree of closeness between the first user and the second user. For example, an affinity indicates that a first user and a second user have close relationship because they follow each other in a social network. In some instances, the one or more other users may be connected to the first user. For example, the one or more users can be friends of the first user. In some instances, the one or more other users may not be connected to the first user. For example, the one or more other users may be users included in one or more suggested connections for the first user.

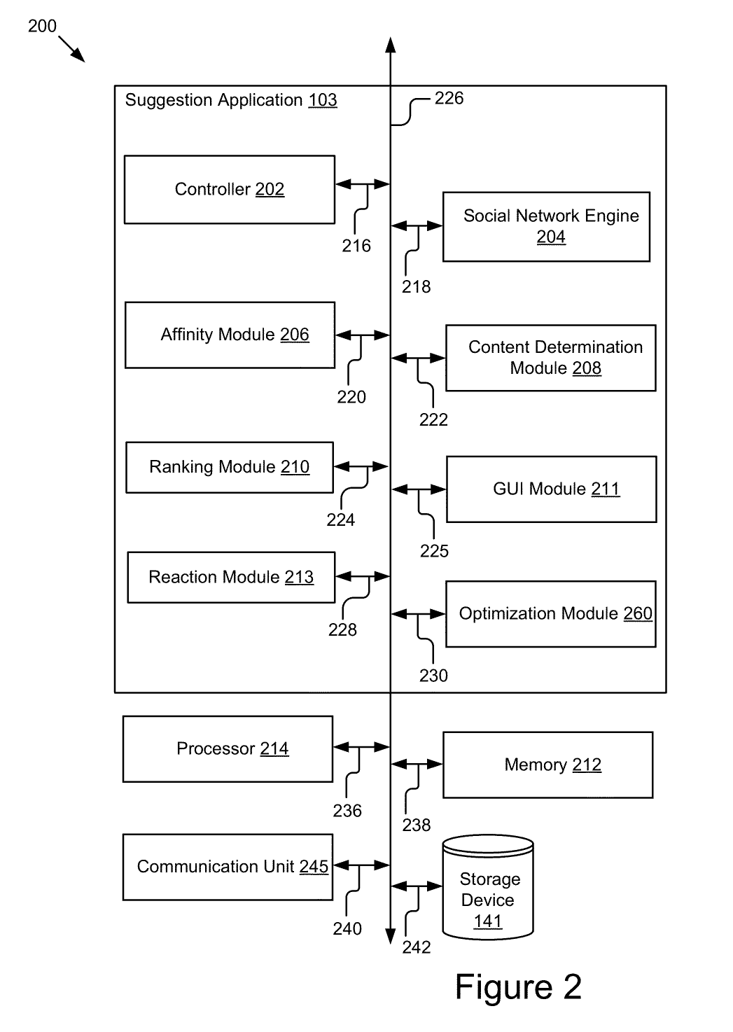

The suggestion application 103 determines a content type (e.g., photos, videos, etc.) and retrieves content (e.g., one or more posts) of the content type published by the one or more other users. The suggestion application 103 optimizes the content and presents the optimized content to the first user in a single post. In some instances, the suggestion application 103 also provides to a first user one or more suggested connections with one or more other users. The suggestion application 103 is described below in more detail with reference to FIGS. 2-5.

The network 105 can be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some instances, the network 105 may be a peer-to-peer network. The network 105 may also be coupled to or includes portions of a telecommunications network for sending data in a variety of different communication protocols. In some instances, the network 105 includes Bluetooth communication networks or a cellular communications network for sending and receiving data including via short messaging service (SMS), multimedia messaging service (MMS), hypertext transfer protocol (HTTP), direct data connection, WAP, email, etc.

Referring now to FIG. 2, an example of the suggestion application 103 is shown in more detail. FIG. 2 is a block diagram of a computing device 200 that includes a suggestion application 103, a processor 214, a memory 212 and a communication unit 245 according to some examples. In some implementations, the computing device 200 additionally includes a storage device 141. The components of the computing device 200 are communicatively coupled by a bus 226. In some instances, the computing device 200 can be one of a social network server 101, a client device 115 and a third-party server 107.

The processor 214 includes an arithmetic logic unit, a microprocessor, a general purpose controller or some other processor array to perform computations and provide electronic display signals to a display device. The processor 214 is coupled to the bus 226 for communication with the other components via signal line 236. Processor 214 processes data signals and may include various computing architectures including a complex instruction set computer (CISC) architecture, a reduced instruction set computer (RISC) architecture, or an architecture implementing a combination of instruction sets. Although FIG. 2 includes a single processor 214, multiple processors 214 may be included. Other processors, operating systems, sensors, displays and physical configurations are possible.

The memory 212 stores instructions and/or data that may be executed by the processor 214. The memory 212 is coupled to the bus 226 for communication with the other components via signal line 238. The instructions and/or data may include code for performing the techniques described herein. The memory 212 may be a dynamic random access memory (DRAM) device, a static random access memory (SRAM) device, flash memory or some other memory device. In some instances, the memory 212 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The communication unit 245 transmits and receives data to and from at least one of the client device 115, the third-party server 107 and the social network server 101 depending upon where the suggestion application 103 may be stored. The communication unit 245 is coupled to the bus 226 via signal line 240. In some instances, the communication unit 245 includes a port for direct physical connection to the network 105 or to another communication channel. For example, the communication unit 245 includes a USB, SD, CAT-5 or similar port for wired communication with the client device 115. In some instances, the communication unit 245 includes a wireless transceiver for exchanging data with the client device 115 or other communication channels using one or more wireless communication methods, including IEEE 802.11, IEEE 802.16, BLUETOOTH® or another suitable wireless communication method.

In some instances, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail or another suitable type of electronic communication. In some instances, the communication unit 245 includes a wired port and a wireless transceiver. The communication unit 245 also provides other conventional connections to the network 105 for distribution of files and/or media objects using standard network protocols including TCP/IP, HTTP, HTTPS and SMTP, etc.

The storage device 141 can be a non-transitory memory that stores data for providing the functionality described herein. The storage device 141 may be a dynamic random access memory (DRAM) device, a static random access memory (SRAM) device, flash memory or some other memory devices. In some instances, the storage device 141 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some instances, the storage device 141 stores content published by one or more users in a social network. For example, the storage device 141 stores one or more posts (e.g., photos, videos, articles, comments, etc.) published by one or more users in a social network. In some implementations, the storage device 141 may store data describing one or more of a social graph and an interest graph. In some instances, an interest graph may be a representation of relationship between people and objects of interest to the people. In the illustrated implementation, the storage device 141 is communicatively coupled to the bus 226 via signal line 242.

In some instances, the storage device 141 stores behavior data describing one or more user behaviors. For example, a user behavior describes that a user interacts with photos presented in a feed, a user interacts with long-form text included in a feed, a user clicks to expand posts and/or comments and a user posts photos after viewing a photo album in a feed, etc. Other examples of user behaviors are possible. Long-form text may be text that includes, for example, more than one sentence. For example, long-form text may be a paragraph.

In some implementations, the behavior data includes reaction data describing one or more user reactions with content presented to one or more users. For example, the reaction data describes that a user interacts with the presented content, that a user's behavior changes after viewing the presented content (e.g., the user posts more photos after viewing a combined photo album from other users) and/or that a user prefers closeness of connection over personal interests (e.g., the user likes photos published by friends and family members more than photos published by other users having a common interest with the user but not connected to the user). Other examples of user reactions are possible.

In the illustrated implementation shown in FIG. 2, the suggestion application 103 includes a controller 202, a social network engine 204, an affinity module 206, a content determination module 208, a ranking module 210, a graphical user interface (GUI) module 211, a reaction module 213 and an optimization module 260. These components of the suggestion application 103 are communicatively coupled to each other via the bus 226.

The controller 202 can be software including routines for handling communications between the suggestion application 103 and other components of the computing device 200. In some instances, the controller 202 can be a set of instructions executable by the processor 214 to provide the functionality described below for handling communications between the suggestion application 103 and other components of the computing device 200. In some other instances, the controller 202 can be stored in the memory 212 of the computing device 200 and can be accessible and executable by the processor 214. The controller 202 may be adapted for cooperation and communication with the processor 214 and other components of the computing device 200 via signal line 216.

The controller 202 sends and receives data, via the communication unit 245, to and from one or more of a client device 115, a social network server 101 and a third-party server 107. For example, the controller 202 receives, via the communication unit 245, a registration request for registering a user with a social network from a client device 115 and sends the registration request to the social network engine 204. In another example, the controller 202 receives graphical data for providing a user interface to a user from the GUI module 211 and sends the graphical data to a client device 115, causing the client device 115 to present the user interface to the user.

In some instances, the controller 202 receives data from components of the suggestion application 103 and stores the data in the storage device 141. For example, the controller 202 receives data describing one or more affinities from the affinity module 206 and stores the data in the storage device 141. In some instances, the controller 202 retrieves data from the storage device 141 and sends the data to components of the suggestion application 103. For example, the controller 202 retrieves data describing a social graph from the storage device 141 and sends the data to the affinity module 206.

The social network engine 204 can be software including routines for registering a user and generating a social network. In some instances, the social network engine 204 can be a set of instructions executable by the processor 214 to provide the functionality described below for registering a user with a social network server 101. In some other instances, the social network engine 204 can be stored in the memory 212 of the computing device 200 and can be accessible and executable by the processor 214. The social network engine 204 may be adapted for cooperation and communication with the processor 214 and other components of the computing device 200 via signal line 218.

In some instances, the social network engine 204 receives a registration request from a user and instructs the GUI module 211 to generate graphical data for providing a registration form to the user. The GUI module 211 sends the graphical data to a client device 115, causing the client device 115 to present the registration form to the user. The user fills out the registration form and sends the registration form to the social network engine 204, causing the social network engine 204 to register the user with a social network provided by the social network server 101.

In some instances, the social network engine 204 receives registration data from a user and registers the user with a social network provided by the social network server 101. The registration data includes, for example, contact data for the user (e.g., a mailing address, a phone number, an email address, etc.), account data describing a social account for the user (e.g., a user name, a password, etc.), privacy settings for the user's social account and the user's acceptance to terms and agreements specified by the social network server 101, etc. Other data may also be included in the registration data.

In some instances, the social network engine 204 receives a connecting request from a first user indicating that the first user requests to connect to a second user in the social network. For example, the connecting request indicates that the first user wants to follow the second user in the social network. The social network engine 204 adds the connection to the social graph. In some instances, the social network engine 204 also generates a connecting invitation which invites the second user to follow the first user and sends the connecting invitation to the second user.

In some instances, the social network engine 204 generates a stream with content from people associated with the user. For example, a first user follows other users and the social network engine 204 generates a stream with content from the other users. The content includes, for example, posts, reshares of other users' content, images, videos, etc.

The affinity module 206 can be software including routines for determining one or more affinities between a first user and one or more other users. In some instances, the affinity module 206 can be a set of instructions executable by the processor 214 to provide the functionality described below for determining one or more affinities between a first user and one or more other users. In some other instances, the affinity module 206 can be stored in the memory 212 of the computing device 200 and can be accessible and executable by the processor 214. The affinity module 206 may be adapted for cooperation and communication with the processor 214 and other components of the computing device 200 via signal line 220.

In some instances, the affinity module 206 determines one or more connections between a first user and one or more other users in a social graph, and determines one or more affinities (e.g., social affinities) between the first user and the one or more other users based at least in part on the one or more connections in the social graph. A social affinity may be an affinity determined based at least in part on a social graph. Examples of a social affinity include, but are not limited to, affinity based on a degree of separation in a social network, a friendship affinity, a family affinity, an acquaintance affinity, etc. A friendship affinity may indicate that a first user lists a second user as a friend in a social network. A family affinity may indicate that a first user lists a second user as a family member in a social network. An acquaintance affinity may indicate that a first user lists a second user as an acquaintance in a social network.

For example, the affinity module 206 retrieves data describing a social graph from the storage device 141 and determines that a first user may follow a second user and the second user follows a third user. The affinity module 206 determines that the affinity between the first user and the second user is closer than the affinity between the first user and the third user because the first user is only connected to the third user through the second user. In another example, the affinity module 206 determines a closer affinity when the relationships include reciprocal connections (e.g. the first user follows the second user and the second user follows the first user) than when the relationship is one sided. In some implementations, the affinity module 206 generates a first affinity score for the first affinity and a second affinity score for the second affinity. The first affinity score may be higher than the second affinity score because the first user has a closer relationship with the second user than with the third user (e.g., a first-degree relationship associated with the first user and the second user is a closer relationship than a second-degree relationship between the first user and the third user).

In some instances, the affinity module 206 determines one or more connections between the first user and one or more other users in an interest graph, and determines one or more affinities (e.g., interest affinities) between the first user and the one or more other users based at least in part on the one or more connections in the interest graph. An interest affinity may be data describing a degree of closeness between a first user and a second user in an interest graph. For example, an interest affinity indicates that a first user and a second user share at least a common interest in an interest graph.

For example, the affinity module 206 retrieves data describing an interest graph from the storage device 141 and determines that the first user may be connected to a second user via two common interests and a third user via a common interest. The affinity module 206 determines a first affinity (e.g., a first interest affinity) between the first user and the second user. The affinity module 206 also determines a second affinity (e.g., a second interest affinity) between the first user and the third user. In some implementations, the affinity module 206 generates a first affinity score for the first affinity and a second affinity score for the second affinity. The first affinity score may be higher than the second affinity score because the first user shares more common interests with the second user than with the third user.

In some other instances, the affinity module 206 determines one or more affinities (e.g., a social affinity, an interest affinity, etc.) between the first user and one or more other users based at least in part on one or more of connections in a social graph and/or connections in an interest graph associated with the first user. In some instances, the affinity module 206 generates a higher affinity score for a social affinity than an interest affinity. In some other instances, the affinity scores may be assigned by an administrator of the system 100. In some implementations, the one or more other users may be users connected to the first user and/or users provided to the first user as suggested connections but not connected to the first user yet.

In some instances, the affinity module 206 ranks the one or more affinities associated with the one or more other users. For example, the affinity module 206 ranks the one or more affinities based at least in part on one or more affinity scores associated with the one or more affinities. For example, assume a first affinity may be a friendship affinity between the first user and a second user and a second affinity may be an acquaintance affinity between the first user and a third user. The affinity module 206 assigns a higher ranking to the first affinity than the second affinity because a friendship affinity has a higher affinity score than an acquaintance affinity.

In some implementations, the affinity module 206 ranks the one or more affinities in an order of social affinities and interest affinities so that the social affinities have the highest rankings and the interest affinities have the lowest rankings Other orders to rank the affinities are possible. In some other implementations, the one or more affinities may be ranked by an administrator of the system 100. In some instances, the affinity module 206 sends one or more affinities having the top rankings (e.g., highest rankings) and identifiers of one or more other users associated with the one or more top-ranking affinities to one or more of the content determination module 208 and the ranking module 210.

The content determination module 208 can be software including routines for determining content to be presented to a first user. In some instances, the content determination module 208 can be a set of instructions executable by the processor 214 to provide the functionality described below for determining content to be presented to a first user. In some other instances, the content determination module 208 can be stored in the memory 212 of the computing device 200 and can be accessible and executable by the processor 214. The content determination module 208 may be adapted for cooperation and communication with the processor 214 and other components of the computing device 200 via signal line 222.

In some instances, the content determination module 208 receives one or more affinities (e.g., one or more top-ranking affinities) between a first user and one or more other users from the affinity module 206. The content determination module 208 evaluates content types available to the first user and determines one or more content types for the first user from the available content types. For example, the content determination module 208 determines that the first user prefers photos as a content type since photos may be compelling content to the first user. Examples of the content types include, but are not limited to, photos, videos, long-form text, group posts and/or event posts, etc. In some implementations, the content determination module 208 favors photos over other content types.

In some instances, the content determination module 208 determines one or more content types for the first user based at least in part on behavior data and/or reaction data associated with the first user. For example, the first user may be a new user to the social network. The content determination module 208 presents different content of various content types published by other users that have different affinities with the first user. The reaction module 213 determines user reactions with the different content from the first user. The reaction module 213 is described below in more detail. If the reaction data describes that the first user tends to click on photos presented in a feed and ignore text included in the feed, the content determination module 208 determines a content type for the first user as a photo type. In another example, if the reaction data describes that the first user tends to read long-form text by clicking to expand posts and/or comments and/or the first user interacts with posts and/or comments that have long-form text, the content determination module 208 determines a content type for the first user as long-form text.

In some instances, the content determination module 208 instructs the optimization module 260 to optimize the content types for the first user. The content determination module 208 receives one or more optimized content types from the optimization module 260. The optimization module 260 and the optimization of content types are described below in more detail. In some instances, the content determination module 208 prioritizes the content types to provide an enriched experience to the first user. For example, the content determination module 208 highlights posts of a content type preferred by the first user and presents the highlighted posts in a dominant portion of a page.

The content determination module 208 determines content published by the one or more other users. In some instances, the content determination module 208 determines the content without imposing a publication time limit on the content. For example, the first user may be a new user to the social network. The determined content for the new user includes posts published one day ago, one month ago, one year ago or five years ago, etc., by the one or more other users (e.g., family members, acquaintances, other users having common interests). In some instances, the content determination module 208 determines content of the one or more determined content types (or of the one or more optimized content types) posted by the one or more other users. For example, the content determination module 208 retrieves content of the one or more content types published by the one or more other users, and determines at least a subset of content from the retrieved content.

In some instances, the determined content includes one or more posts published by the one or more other users. For example, the determined content includes one or more posts published by a second user from the one or more other users and one or more posts published by a third user from the one or more other users. In some implementations, the one or more other users may be users connected to the first user (e.g., followed by the first user) and/or users provided to the first user as suggested connections but not connected to the first user yet.

In some instances, the content determination module 208 determines contextual data associated with the first user. Contextual data may be data describing a context of a user. Examples of contextual data associated with a user include, but are not limited to, data describing one or more of personal interests, education and/or working experience and demographic data. The content determination module 208 also determines metadata associated with the posts published by the one or more other users. Examples of metadata associated with a post include, but are not limited to, a title of the post, a subject of the post (e.g., a technology subject, a tourism subject, a vacation subject, etc.), a keyword for the post, a location related to the post, a brief description for the content included in the post and a device used to publish the post.

The content determination module 208 determines the content from the retrieved content based at least in part on the contextual data and the metadata. For example, if the contextual data indicates that the first user likes to take a vacation in summer, the content determination module 208 determines a subset of posts associated with a vacation subject from the posts published by the one or more other users. In another example, if the contextual data indicates that the first user may be interested in a particular type of camera, the content determination module 208 selects photos taken by the particular type of camera from the photos posted by the one or more other users. The content determination module 208 may also highlight and annotate the selected photos using a larger image size.

In some implementations, if the determined content type includes a photo type, the content determination module 208 retrieves a first set of photos published by the one or more other users. The content determination module 208 identifies metadata associated with the first set of photos (e.g., people tagged in the photos, locations in the photos, a type of cameras used to take the photos, subjects in the photos (e.g., beaches, points of interest, mountains, etc.)). The content determination module 208 determines one or more photos from the first set of photos based at least in part on the metadata. For example, the content determination module 208 selects a photo from the first set of photos published by a second user because the first user may be tagged in the photo.

In some instances, the content determination module 208 determines content published by the one or more other users based at least in part on behavior data and/or reaction data associated with the first user. For example, if the behavior data describes that the first user has sent a message to a second user discussing a sports game, the content determination module 208 identifies content that includes one or more photos published by the second user that may be related to the sports game. In another example, the behavior data describes that the first user has been shown 10 impressions of a first photo from a second user but the first user has not clicked on the first photo. The first user has also been shown five impression of a second photo from a third user and clicked on the second photo four times. The content determination module 208 determines that the content should include more photos from the third user than from the second user based on the behavior data. In some instances, the third user may have a higher affinity score than the second user.

In some instances, the content determination module 208 combines the determined content to generate a post. For example, the content determination module 208 combines the content by person and/or by interest to generate a post. In some instances, the post includes photos across multiple photo albums from another user or multiple other users. The content may be ranked by the ranking module 210 according to user interests. In some other instances, the content determination module 208 instructs the ranking module 210 to rank the determined content. The ranking module 210 is described below in more detail. The content determination module 208 receives the top-ranking content from the ranking module 210 and generates a post from the top-ranking content.

In some implementations, the content determination module 208 combines the determined content (or the top-ranking content) based on one or more affinities between the first user and the one or more other users. For example, the content determination module 208 combines photos from one or more photo albums published by the one or more other users to generate a combined photo album based on affinities associated with the other users. The combined photo album may include one or more photos across one or more photo albums published by the one or more other users. For example, the combined photo album includes a first photo from a first photo album of a friend, a second photo from a second photo album of the same friend and a third photo from a third photo album of a family member. In some implementations, the content determination module 208 lists the third photo before the first and second photos in the combined photo album because the third photo may be associated with the family member who has a higher affinity than the friend. In some instances, the content determination module 208 modifies the photos as a function of the affinity. For example, the content determination module 208 highlights the third photo using a larger size than the first and second photos.

In some implementations, the content determination module 208 combines the determined content (or the top-ranking content) based on topics and/or locations of the content. For example, the content determination module 208 generates a combined photo album including photos depicting outdoor environment since the first user likes outdoor activities. In some implementations, the content determination module 208 generates a post based on a chronological order of the publication time associated with the content. In another example, the content determination module 208 highlights content matching the first user's contextual data by using a larger size, different colors and different text fonts, etc.

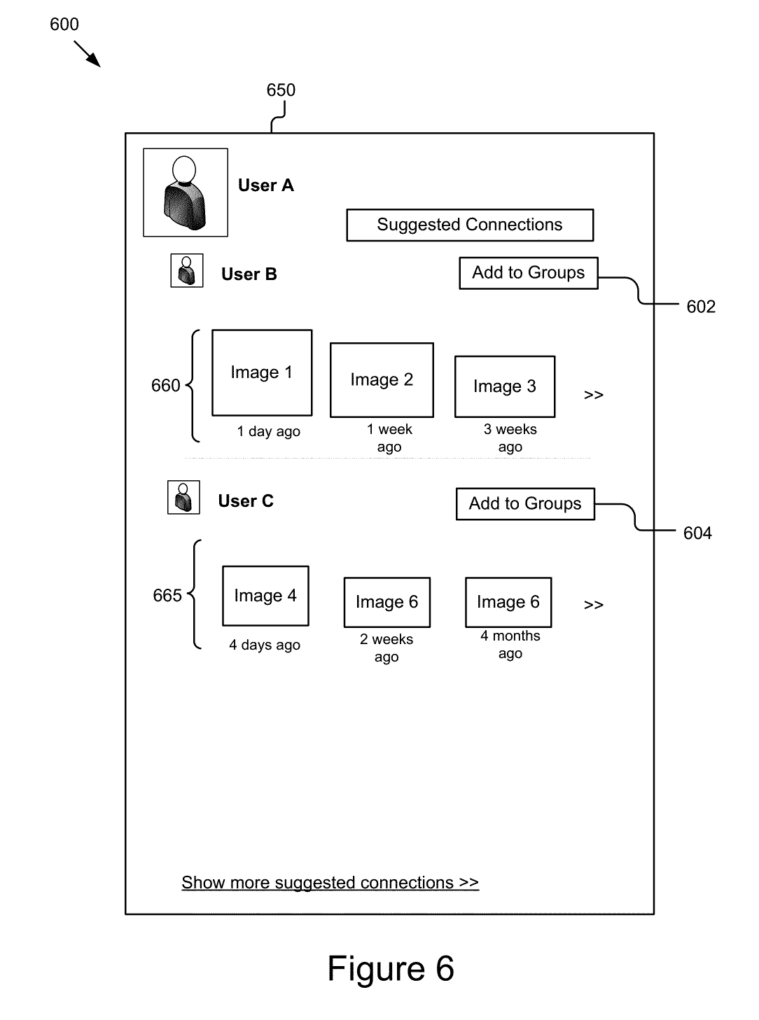

The content determination module 208 provides one or more of the determined content and/or the post to the first user. In some instances, the content determination module 208 provides one or more of a post, a combined photo album, one or more top-ranking pieces of content (e.g., content with the highest rankings), content optimized for the content type and content optimized for a specific list of friends, to the first user. Content optimized for the content type and content optimized for a specific list of friends are described below in more detail. In some instances, the content determination module 208 generates a feed that includes the provided content and sends the feed to the first user. For example, the content determination module 208 sends the feed to the GUI module 211, causing the GUI module 211 to generate graphical data for displaying a user interface depicting the feed to the first user. Example of user interfaces for providing the feed are shown in FIG. 6-8.

The ranking module 210 can be software including routines for ranking content. In some instances, the ranking module 210 can be a set of instructions executable by the processor 214 to provide the functionality described below for ranking content. In some other instances, the ranking module 210 can be stored in the memory 212 of the computing device 200 and can be accessible and executable by the processor 214. The ranking module 210 may be adapted for cooperation and communication with the processor 214 and other components of the computing device 200 via signal line 224.

In some instances, the ranking module 210 receives the determined content (or a post) from the content determination module 208. The ranking module 210 ranks the content based at least in part on one or more affinities between a first user and one or more other users. For example, the content includes one or more photos, and the ranking module 210 determines a higher ranking for a first photo published by a close friend than a second photo published by an acquaintance because the first user has a higher affinity with the close friend than with the acquaintance. In some instances, the ranking module 210 favors affinities over publication time when ranking the content. For example, the ranking module 210 determines a higher ranking for a first post published by a family member than a second post published by another user sharing common interests even if the first post was published one month ago and the second post was published ten minutes ago.

In some instances, the ranking module 210 ranks the content based at least in part on one or more of contextual data, behavior data and reaction data associated with the first user. For example, if the contextual data indicates that the first user favors football games over basket games, the ranking module 210 determines a higher ranking for a photo depicting a football game than a photo depicting a basketball game. In another example, if the behavior data indicates that the first user clicks on photos related to ancient architecture and does not click on photos related to modern architecture, the ranking module 210 determines a higher ranking for a photo depicting an ancient building than a photo depicting a modern building. In some instances, the ranking module 210 ranks the content based at least in part on the content type. For example, the ranking module 210 determines a higher ranking for a photo post than a long-form text post because a photo may be more compelling than a large amount of text.

In some instances, the ranking module 210 sends the top-ranking content (e.g., top 10 posts, top 20 posts, etc.) to the content determination module 208.

The GUI module 211 can be software including routines for generating graphical data for providing user interfaces to users. In some instances, the GUI module 211 can be a set of instructions executable by the processor 214 to provide the functionality described below for generating graphical data for providing user interfaces. In some other instances, the GUI module 211 can be stored in the memory 212 of the computing device 200 and can be accessible and executable by the processor 214. The GUI module 211 may be adapted for cooperation and communication with the processor 214 and other components of the computing device 200 via signal line 225.

In some instances, the GUI module 211 generates graphical data for providing a user interface that depicts a registration form. The GUI module 211 sends the graphical data to a client device 115 operated by a user, causing the client device 115 to present the registration form to the user via the user interface. In some instances, the GUI module 211 generates graphical data for providing a user interface that depicts a feed. The GUI module 211 sends the graphical data to a client device 115, causing the client device 115 to present the user interface to the user. The feed includes, for example, posts published by other users and one or more suggested connections. Examples of the user interface are shown in FIGS. 6-8. The GUI module 211 may generate graphical data for providing other user interfaces to users.

In some instances, the GUI module 211 generates graphical data for displaying an electronic message for that user that are transmitted via the communication unit 245. For example, the social network engine 204 instructs the GUI module 211 to generate graphical data for displaying an electronic message welcoming the user to the social network after the user completes registration. In some instances, the GUI module 211 generates graphical data for displaying the content with suggested users and content types as part of the electronic message.

The reaction module 213 can be software including routines for determining a user reaction with content presented to the user. In some instances, the reaction module 213 can be a set of instructions executable by the processor 214 to provide the functionality described below for determining a user reaction with content presented to the user. In some other instances, the reaction module 213 can be stored in the memory 212 of the computing device 200 and can be accessible and executable by the processor 214. The reaction module 213 may be adapted for cooperation and communication with the processor 214 and other components of the computing device 200 via signal line 228.

In some instances, the GUI module 211 presents a feed including one or more posts from one or more other users to a first user. The reaction module 213 determines the first user's reaction with the presented feed. For example, the reaction module 213 determines whether the first user prefers more posts organized by a content type (e.g., more posts of a photo type) or more posts from other users connected to the first user (e.g., more posts from friends). In some implementations, the reaction module 213 determines whether the first user interacts with the presented content, whether the first user's behavior changes after viewing the presented content (e.g., whether the first user posts more photos after viewing a combined photo album from other users), or whether the first user prefers closeness of connection over personal interests between the first user and other users (e.g., whether the first user likes photos published by people in a group created by the first user more than photos published by other users having a common interest with the first user but who are not connected to the first user).

Other examples of user reactions (or, user behaviors) include, but not limited to, that a user tends to click on photos presented in a feed and ignore text included in the feed, a user tends to read long-form text by clicking to expand posts and/or comments, a user interacts with posts and/or comments that have long-form text and not short-form text, a user posts certain types of content after viewing the presented content, a user engages with providing feedback to the posts and a user adds suggested connections to the user's groups, etc. Other examples of user reactions are possible.

In some instances, the reaction module 213 updates the presentation of the content based at least in part on the first user's reaction. For example, the reaction module 213 updates the presentation of content based at least in part on a preference of the first user. For example, if the first user prefers posts from friends than posts from other users not connected to the first user, the reaction module 213 instructs the content determination module 208 to provide more posts from friends and fewer posts from the other users to the first user. In some implementations, if the first user has not finished viewing the presented posts, the reaction module 213 emails the feed to the first user so that the first user may continue viewing the posts at a later time. The reaction module 213 stores reaction data describing the user reactions in the storage device 141.

The optimization module 260 can be software including routines for optimizing content. In some instances, the optimization module 260 can be a set of instructions executable by the processor 214 to provide the functionality described below for optimizing content. In some other instances, the optimization module 260 can be stored in the memory 212 of the computing device 200 and can be accessible and executable by the processor 214. The optimization module 260 may be adapted for cooperation and communication with the processor 214 and other components of the computing device 200 via signal line 230.

In some instances, the optimization module 260 optimizes one or more content types for a first user. The optimization module 260 aggregates one or more user activities (e.g., one or more user behaviors) associated with the first user to determine which user activity may be encouraged. For example, the optimization module 260 determines which activity may encourage the first user to engage in the social network. In another example, the optimization module 260 determines which activity may enhance the user experience in the social network. The optimization module 260 determines an optimized content type as one that may drive the encouraged activity. For example, if photos encourage the first user to engage in the social network, the optimization module 260 determines an optimized content type for the first user as a photo type.

In some implementations, the optimization module 260 determines one or more available content types for the first user. For example, if the posts published by one or more other users (e.g., users connected to the first users or included in one or more suggested connections to the first user) include photos and long-form text, the optimization module 260 determines that the one or more available content types for the first user include a photo type and long-form text. If the posts do not include group posts, the one or more available content types for the first user do not include group posts.

In some implementations, the optimization module 260 determines one or more featured content types associated with a social network. Examples of a featured content type include, but are not limited to, a content type that may be preferred by a social network (e.g., a photo type that may be preferred by a social network featuring photo sharing, a video type that may be preferred by a video hosting site, etc.), a content type that drives user engagement, a content type that drives growth and a content type that retains users, etc.

In some implementations, the optimization module 260 instructs the content determination module 208 to retrieve and provide content of certain content types to the first user in a social feed. In some instances, the content may be provided to the first user in a variety of locations in a web page (e.g., left/right side, top or bottom of the web page, search results in the web page). The optimization module 260 instructs the reaction module 213 to determine user reactions associated with the content. For example, the optimization module 260 instructs the reaction module 213 to measure user reactions including impressions, clicks and engagement, and receives reaction data from the reaction module 213. For example, the reaction data indicates that the first user clicks on photos and ignores long-form text in the presented content. In some implementations, the optimization module 260 weighs impressions of content related to contextual data of the first user over other impressions. In some implementations, the optimization module 260 weighs impressions related to content presented in a dominant portion of a web page over other impressions presented in marginal portions of the web page.

The optimization module 260 determines one or more optimized content types based at least in part on one or more of the available content types, the one or more featured content types and reaction data describing one or more user reactions. For example, if the available content types include a photo type and long-form text, the featured content types include a photo type and the reaction data indicates that the first user favors photos over long-form text, the optimization module 260 determines an optimized content type as a photo type.

In some instances, the optimization module 260 receives content from the content determination module 208. The optimization module 260 optimizes the content based at least in part on the content type associated with the content. For example, if the content type includes photos, the optimization module 260 optimizes the content to generate a combined photo album as described above. If the content type includes short-form text, the optimization module 260 optimizes the content to generate a list of long-form text. The optimization module 260 identifies that the first user prefers long-form text, and expands the long-form text in the list in a full scale. If the content type includes one of group posts and event posts, the optimization module 260 optimizes the content to generate one of an aggregation of group posts and an aggregation of event posts based at least in part on one or more affinities, respectively.

In some implementations, the optimization module 260 optimizes the content based at least in part on a specific list of friends. For example, the optimization module 260 optimizes the content to generate a subset of content published by friends included in the specific list. In another example, the optimization module 260 highlights a subset of content published by friends included in the specific list by using different sizes of photos, different color and font size for the text, etc.

In some instances, the optimization module 260 sends one or more of the optimized content types, content optimized by a content type and content optimized by a specific list of friends to the content determination module 208.

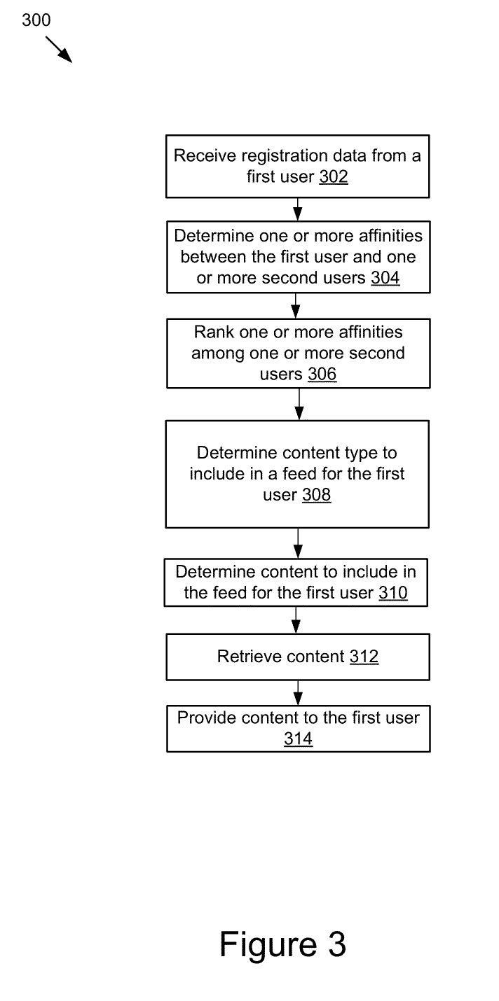

Referring now to FIG. 3, an example of a method 300 for providing content to users is described. In some instances, the controller 202 receives 302 registration data from a first user and sends the registration data to the social network engine 204. The social network engine 204 registers the first user with the social network. The affinity module 206 determines 304 one or more affinities between the first user and one or more second users. The affinity module 206 ranks 306 the one or more affinities among the one or more second users. The content determination module 208 determines 308 a content type to include in a feed for the first user. The content determination module 208 determines 310 content of the content type to include in the feed for the first user. The content determination module 208 retrieves 312 the content and provides 314 the content to the first user.

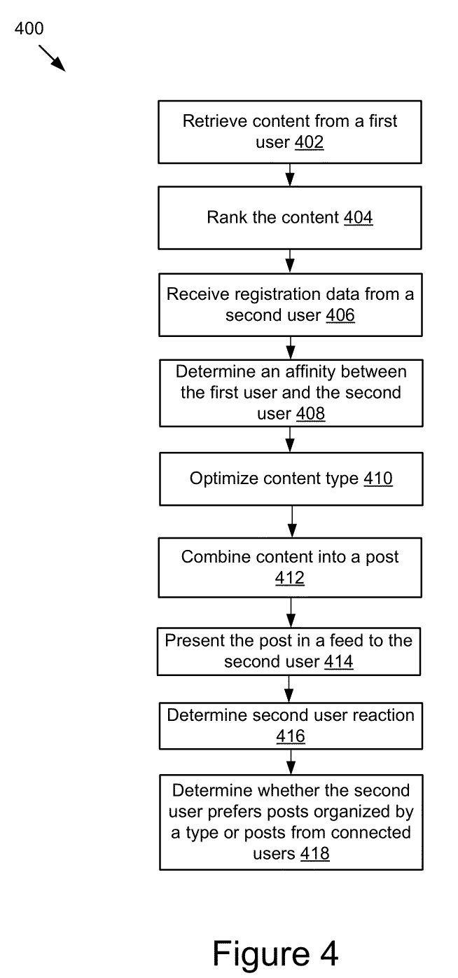

Referring now to FIG. 4, another example of a method 400 for providing content to users is described. In some implementations, the controller 202 retrieves 402 content from a first user. The ranking module 210 ranks 404 the retrieved content. The controller 202 receives 406 registration data from a second user and sends the registration data to the social network engine 204. The social network engine 204 registers the second user with the social network server 101. The affinity module 206 determines 408 an affinity between the first user and the second user. The optimization module 260 optimizes 410 a content type for the second user.

The content determination module 208 determines content of the optimized content type from the ranked content. The content determination module 208 combines 412 the content of the optimized content type to generate a post. The content determination module 208 presents 414 the post in a feed to the second user. The reaction module 213 determines 416 the second user's reaction to the presented post. The reaction module 213 determines 418 whether the second user prefers posts organized by a content type or posts from connected users. In some instances, the reaction module 213 updates the presentation of posts based at least in part on the second user's reaction.

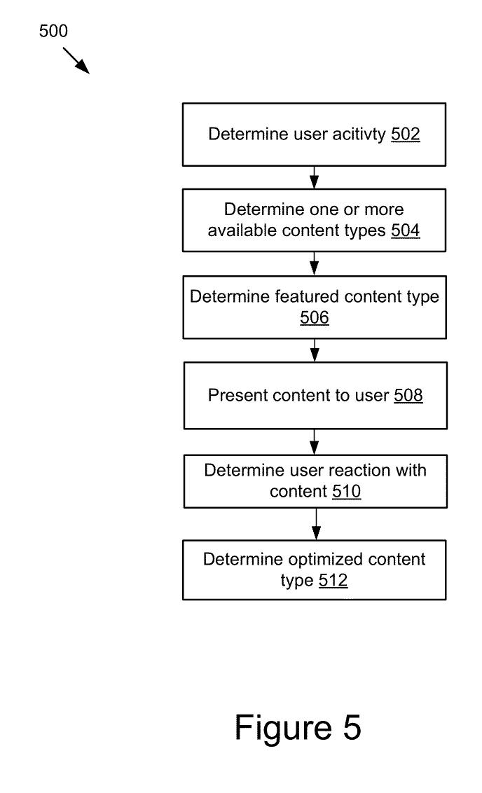

Referring now to FIG. 5, an example of a method 500 for optimizing one or more content types is described. The optimization module 260 determines 502 one or more user activities associated with a first user. The optimization module 260 determines 504 one or more available content types for the first user. The optimization module 260 determines 506 one or more featured content types in a social network. The optimization module 260 instructs the content determination module 208 to present 508 content to the first user. The optimization module 260 instructs the reaction module 213 to determine 510 one or more user reactions with the presented content. The optimization module 260 determines 512 one or more optimized content types for the first user based at least in part on one or more of reaction data describing the one or more user reactions, the one or more available content types and the one or more featured content types.

FIG. 6 is a graphic representation 600 of an example user interface 650 for providing content to a user. In the illustrated implementation, the user interface 650 includes one or more suggested connections for User A. For example, User A may connect to User B by clicking on a first “Add to Groups” button 602. User A may also connect to User C by clicking on a second “Add to Groups” button 604. The user interface 650 includes a first set of photos 660 posted by User B and a second set of photos 665 posted by User C. In some implementations, the first set of photos 660 and the second set of photos 665 may be depicted using different image sizes. For example, the first set of photos 660 may be highlighted by depicting in larger image sizes than the second set of photos 665 because User A has a higher affinity with User B than with User C. In another example, a first photo in the first set of photos 660 may be depicted in a larger image size than a second photo in the same set because User A may be tagged in the first photo.

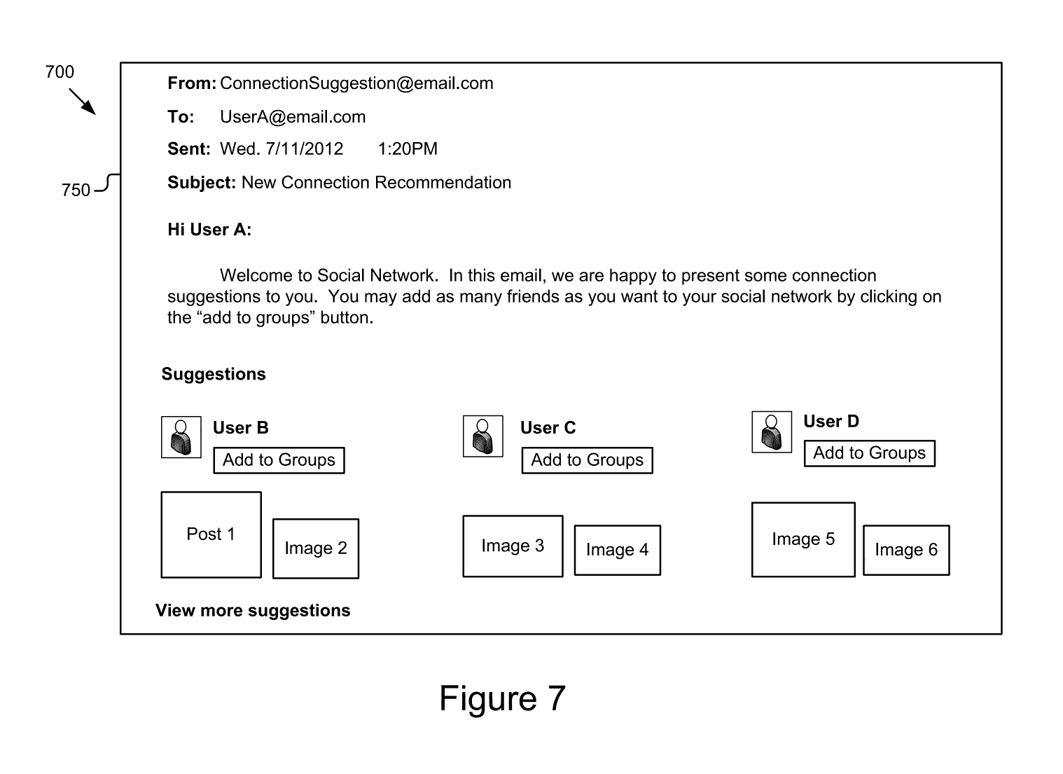

FIG. 7 is a graphic representation 700 of an example user interface 750 for providing content to a user as part of an electronic message. In this example, suggested content is displayed in association with each user with differing sizes based on the perceived interest that the user will find in each type of content or the subject matter associated with the content.

FIG. 8 is a graphic representation 800 of an example user interface 850 for a website generated by the third-party server 107 where the suggestion application 103 generates content that is displayed on the same website. In this example, the content determination module 208 generates albums around a topic. Specifically, the content determination module 208 generates an album about the Super Bowl 884 and another album about the most beautiful beaches in the world 886. For the album about the Super Bowl 884, the photo number out of a total number of photos from the given album it was added from is shown, and the time ago the photo was added is shown. The album about the most beautiful beaches in the world 886 shows another version of an automatically created album that lets the user identify the people, places, topics, etc. posted based on either showing a profile photo of the creator on the photo, or providing a list of people, places, topics, etc. on the side that when hovered on or clicked can identify and/or cause to be presented the photos by or of those people, places, topics, etc.

In the above description, for purposes of explanation, numerous specific details are set forth in order to provide a thorough understanding of the specification. It will be apparent, however, to one skilled in the art that the technology can be practiced without these specific details. In other instances, structures and devices are shown in block diagram form in order to avoid obscuring the description. For example, the present implementation is described in one implementation below primarily with reference to user interfaces and particular hardware. However, the specification applies to any type of computing device that can receive data and commands, and any peripheral devices providing services.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware implementation, an entirely software implementation or an implementation containing both hardware and software elements. In a preferred implementation, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. A method comprising:
determining, with one or more computing devices, one or more affinities between a first user and one or more second users, the one or more affinities between the first user and the one or more second users indicating degrees of closeness between the first user and the one or more second users in a graph describing connections in a social network;
determining, with the one or more computing devices, a content type for the first user from a plurality of content types based on the first user's preference for content type, the content type specifying a type of media and the plurality of content types being published by the one or more second users;
determining, with the one or more computing devices, at least two pieces of content of the determined content type published by the one or more second users;
combining, with the one or more computing devices, the at least two pieces of determined content to generate a post based on the one or more affinities; and
providing the post to the first user.

2. The method of claim 1, further comprising the step of highlighting one of the pieces of content in the post based on the affinity between the first user and the second user.

3. The method of claim 1, further comprising:
ranking the determined content based on the one or more affinities; and
generating the post based on one or more top-ranking pieces of content from the one or more pieces of content.

4. The method of claim 1, wherein the determined content includes one or more photo albums published by the one or more second users and the post includes a combined photo album including one or more photos from the one or more photo albums.

5. The method of claim 1, further comprising:
determining a user reaction to the post from the first user; and
updating content presentation based on the user reaction.

6. The method of claim 1, wherein determining the content comprises:
determining contextual data associated with the first user;
determining metadata associated with a set of posts published by the one or more second users; and
determining a subset of posts from the set of posts based on the metadata and the contextual data.

7. The method of claim 1, wherein the determination of the content is based on behavior data associated with the first user.

8. The method of claim 1, further comprising:
ranking the one or more affinities among the one or more second users based on one or more connections between the first user and the one or more second users.

9. A computer program product comprising a non-transitory computer usable medium including a computer readable program, wherein the computer readable program when executed on a computer causes the computer to:
determine one or more affinities between a first user and one or more second users, the one or more affinities between the first user and the one or more second users indicating degrees of closeness between the first user and the one or more second users in a graph describing connections in a social network;
determine a content type for the first user from a plurality of content types based on the first user's preference for content type, the content type specifying a type of media and the plurality of content types being published by the one or more second users;
determine at least two pieces of content of the determined content type published by the one or more second users;
combine the at least two pieces of determined content to generate a post based on the one or more affinities; and
provide the post to the first user.

10. The computer program product of claim 9, wherein the computer readable program when executed on the computer causes the computer to also:
highlight one of the pieces of content in the post based on the affinity between the first user and the second user.

11. The computer program product of claim 9, wherein the computer readable program when executed on the computer causes the computer to also:
rank the determined content based on the one or more affinities; and
generate the post based on one or more top-ranking pieces of content from the one or more pieces of content.

12. The computer program product of claim 9, wherein the determined content includes one or more photo albums published by the one or more second users and the post includes a combined photo album including one or more photos from the one or more photo albums.

13. The computer program product of claim 9, wherein the computer readable program when executed on the computer causes the computer to also:
determine a user reaction to the post from the first user; and
update content presentation based on the user reaction.

14. The computer program product of claim 9, wherein determining the content comprises:
determining contextual data associated with the first user;
determining metadata associated with a set of posts published by the one or more second users; and
determining a subset of posts from the set of posts based on the metadata and the contextual data.

15. The computer program product of claim 9, wherein the determination of the content is based on behavior data associated with the first user.

16. The computer program product of claim 9, wherein the computer readable program when executed on the computer causes the computer to also:
rank the one or more affinities among the one or more second users based on one or more connections between the first user and the one or more second users.

17. A system comprising:
one or more processors; and
a memory storing instructions that, when executed, cause the system to:
determine one or more affinities between a first user and one or more second users, the one or more affinities between the first user and the one or more second users indicating degrees of closeness between the first user and the one or more second users in a graph describing connections in a social network;
determine a content type for the first user from a plurality of content types based on the first user's preference for content type, the content type specifying a type of media and the plurality of content types being published by the one or more second users;
determine at least two pieces of content of the determined content type published by the one or more second users;
combine the at least two pieces of determined content to generate a post based on the one or more affinities; and
provide the post to the first user.

18. The system of claim 17, wherein the one or more processors are further configured to highlight one of the pieces of content in the post content based on the affinity between the first user and the second user.

19. The system of claim 17, wherein the one or more processors are further configured to rank the determined content based on the one or more affinities and wherein the post is generated based on one or more top-ranking pieces of content from the one or more pieces of content.

20. The system of claim 18, wherein the determined content includes one or more photo albums published by the one or more second users and the post includes a combined photo album including one or more photos from the one or more photo albums.
